(19) United States
(12) Patent Application Publication
(10) Pub. No.: US 2010/0163586 A1
(43) Pub. Date: Jul. 1, 2010

(54) STOPPER STRUCTURE AND PRODUCTION METHOD THEREFOR

(75) Inventors: Junichi Funato, Fukuoka (JP); Takahiro Azuma, Fukuoka (JP)

Correspondence Address: Fleit Gibbons Gutman Bongini & Bianco PL, 21355 EAST DIXIE HIGHWAY, SUITE 115, MIAMI, FL, 33180, US

(73) Assignee: KROSAKIHARIMA CORPORATION, Fukuoka (JP)

(21) Appl. No.: 12/524,962

(22) PCT Filed: Feb. 5, 2008
(86) PCT No.: PCT/JP2008/051874

§ 371 Date: Jan. 19, 2010

(30) Foreign Application Priority Data
Feb. 7, 2007 (JP) 2007-028593

(51) Int. Cl. B22D 41/16; C04B 35/64

(52) U.S. Cl. 222/602; 264/642

(57) ABSTRACT

The present invention provides a stopper structure capable of preventing loosening of a shaft rod during use, and gas leakage which is likely to occur when the stopper structure is designed to allow gas to pass therethrough. The shaft rod 1 is adapted to be mounted in a mounting hole 2a of a refractory stopper 2, and formed to have an outer peripheral surface including a first tapered sub-surface 4a which increases in diameter toward an axially lower edge of the shaft rod. The mounting hole 2a of the refractory stopper 2 is formed to have an inner surface including a second tapered sub-surface 4b adapted to come into surface contact with the first tapered sub-surface 4a. The shaft rod 1 is adapted to be fastened to the refractory stopper so as to allow the first tapered sub-surface 4a to be brought into close surface contact with the second tapered sub-surface 4b. The distal end of the shaft rod 1 is formed in a configuration satisfying the following relation: tan θ≦D/2A, wherein: A is a length of the shaft rod 1 between a position of the shaft rod 1 corresponding to an upper edge surface 2S of the refractory stopper, and a start position of the first tapered sub-surface 4a; D is an outer diameter of the first tapered sub-surface 4a at the start position; and θ is a taper angle of the first tapered sub-surface 4a.

### TECHNICAL FIELD

The present invention relates to a stopper structure designed to be used, during an operation of discharging molten metal from a vessel via a nozzle, for controlling start and stop of the discharge and a flow rate of the molten metal (hereinafter referred to collectively as “discharge control”), and more particularly to a stopper structure which comprises a refractory stopper serving as a main body thereof, and a shaft rod mounted in the refractory stopper to allow the refractory stopper to be connected to a drive unit.

### BACKGROUND ART

As a method for performing a discharge control during an operation of discharging molten metal from a vessel via a nozzle, there has been known a technique of arranging a stopper structure inside the vessel, and operating the stopper structure to selectively open and close an interspace defined between a fitting portion thereof and an upper end of the nozzle.

Generally, the stopper structure comprises a refractory stopper which is integrally made of a refractory material and adapted to be partly immersed in molten metal, and a shaft rod which is made of a metal, and mounted to an upper portion of the refractory stopper to be not immersed in molten metal, in such a manner as to allow the refractory stopper to be connected to a drive unit during use. In this stopper structure, it is a common practice to provide a gas passage penetrating through between an upper end (base end) of the metal shaft rod to a lower end (distal end) of the refractory stopper, and supply inert gas through the gas passage so as to inject the inert gas from the distal end of the refractory stopper into molten metal, or to circulate cooling gas, such as air, so as to maintain the metal shaft rod at a given temperature or less.

In many cases, the stopper structure is fabricated in a casting workplace by fixedly screwing a first externally threaded portion of the metal shaft rod into a hole which is formed in an upper end of the refractory stopper to have an internally threaded portion engageable with the first externally threaded portion of the shaft rod, while interposing therebetween a material having a bonding function and a sealing function, such as joint filler including mortar (the material hereinafter is referred to collectively as “bonding material”), and hardening the bonding material to integrate the metal shaft rod and the refractory stopper together. The shaft rod is further formed with a second externally threaded portion in an upper end thereof, and connected to a stopper drive unit through a metal cylindrical-shaped shaft rod or arm having an internally threaded portion engaged with the second externally threaded portion.

However, in the stopper structure designed to mount a part of the metal shaft rod inside the refractory stopper, the metal having a thermal expansibility fairly greater than that of the refractory stopper is brought into close contact with an inner surface of the refractory stopper. Thus, thermal expansion of the metal is likely to cause breakage of a portion of the refractory stopper surrounding the metal.

As one of the measures for preventing such breakage, the bonding material, such as mortar, to be interposed between the shaft rod and the refractory stopper, is required to have a function of adequately absorbing thermal expansion of the metal shaft rod, such as compressability or deformability. However, the use of this type of bonding material is likely to cause a problem, such as loosening between the metal shaft rod and the refractory stopper, due to deformation or collapse of the bonding material. Consequently, stress concentration occurs in a local area of the refractory stopper to cause a risk of breakage of the refractory stopper. Moreover, when the stopper structure is designed to allow gas to pass therethrough, a risk of gas leakage and sucking of external air will also increase.

In a process of producing the above stopper structure, in view of production efficiency, it is desirable to subject a refractory material for the refractory stopper to shaping and burning, while setting a part of the metal shaft rod within the refractory material. In reality, the refractory material cannot be subjected to burning while setting a part of the metal shaft rod within the refractory material, because thermal expansion of the metal shaft rod causes breakage of a portion of the refractory material surrounding the metal shaft rod. Although a gap or a cushioning material may be provided around the metal shaft rod to absorb the thermal expansion, the gap or cushioning material precludes a possibility of obtaining sufficient fixing (fastening) and contact.

When the stopper structure is partly immersed in molten steel, it receives strong buoyancy from the molten steel having a specific gravity of about 7. This buoyancy and other external force are supported only by a joining portion between the shaft rod and the upper end region of the refractory stopper. Thus, even if the refractory stopper is only slightly inclined, a large moment is applied to the support region, and stress concentration is highly likely to occur in a local area of the joining portion to cause breakage of the refractory stopper and other associated member. Particularly, in cases where there is strong turbulence in a molten steel stream around the refractory stopper, due to gas injected into molten steel, from the distal end of the refractory stopper or from a nozzle, such as an upper nozzle, disposed on a downstream side relative to the refractory stopper, the refractory stopper constantly undergoes vibration, and then a complicated stress is constantly applied to the joining portion between the refractory stopper and the shaft rod, in a varying manner.

As above, the joining portion between the refractory stopper and the shaft rod is exposed under severe thermal and mechanical stress conditions. Thus, in addition to complexity and laboriousness in the shaft rod mounting operation in a casting workplace, high mounting accuracy is required, particularly, for preventing gas leakage in the stopper structure designed to allow gas to pass therethrough. This imposes a heavy burden on a user. Moreover, even after the mounting operation having such a heavy burden, the fixed (fastened) state between the shaft rod and the refractory stopper has to be constantly corrected by a retorquing operation or the like, because loosening between the shaft rod and the refractory stopper occurs due to thermal expansion of the shaft rod and continuous action of varying external force, such as vibration, during casting operation. Even if the mounting operation is carefully performed with a high degree of accuracy, and the correction operation, such as retorquing operation, is intermittently performed, there still remains a problem of being unable to completely avoid breakage of the refractory stopper and the bonding material, and gas leakage, in the upper end region of the refractory stopper.

As measures against the above problems, for example, the following Patent Document 1 discloses a technique of pre-embedding a shaft-rod joining member (bushing insert) made of stainless steel, in an upper portion of a refractory stopper during its production process, to protect the refractory stopper.

FIG. 6 is a sectional view showing one example of a stopper structure using this technique. Specifically, a cylindrical-shaped, metal, shaft-rod joining member 14 having an internally threaded portion is embedded in an upper portion of a refractory stopper 2, and a distal end of a metal shaft rod 1 is screwingly mounted to the shaft-rod joining member 14. Further, a seat plate 3 is screwed with the shaft rod 1. The shaft rod 1 is fastened to the refractory stopper 2 by screwing the seat plate 3 toward an upper surface 2S of the refractory stopper. Each of the shaft rod 1 and the refractory stopper 2 is formed with a gas passage penetrating therethrough, and inert gas is supplied to the gas passage 7, and injected from a distal end of the refractory stopper 2 into molten metal. In order to prevent gas leakage from between the shaft rod 1 and the refractory stopper 2, a sealing material 5 is provided between an inner surface of the seat plate 3 and an externally threaded portion 1c of the shaft rod 1.

The shaft-rod joining member 14 may be mounted in the refractory stopper 2 by inserting a material having a bonding function and a thermal expansion-absorbing function, such as mortar, into a recess pre-formed in the upper portion of the refractory stopper 2, and subjecting the bonding/expansion-absorbing material to a hardening process, such as drying. Alternatively, the shaft-rod joining member 14 may be mounted in the refractory stopper 2 in conjunction with an isostatic pressing process for forming the refractory stopper by embedding the shaft-rod joining member 14 in a mixture (ingredients) as a material of the refractory stopper, in a rubber mold.

However, in the stopper structure designed to mount the cylindrical-shaped, metal, shaft-rod joining member inside the refractory stopper 2, due to thermal expansion of the metal shaft rod 1 along with an increase in temperature thereof during use, the metal, shaft-rod joining member 14 embedded in the refractory stopper 2 is likely to break a portion of the refractory stopper surrounding the shaft-rod joining member 14. Moreover, due to elongation of a vertical length of the shaft rod 1, loosening (gap) between the shaft rod 1 and the refractory stopper 2 occurs to cause instability in fixed (fastened) state between the shaft rod 1 and the refractory stopper 2, and difficulty in ensuring gas-tightness therebetween, which leads to gas leakage. Furthermore, a contact region between the shaft rod 1 and the refractory stopper 2 locally occurs, and triggers a higher risk of breakage of the refractory stopper.

In view of the risk that the refractory stopper 2 is pressingly broken during use due to thermal expansion of the metal, shaft-rod joining member 14 mounted in the refractory stopper 2, there has also been proposed a stopper structure designed to mount a shaft-rod joining member made of a ceramic material having a thermal expansion less than that of a metal. However, even if such a shaft-rod joining member having relatively small thermal expansion is pre-mounted, it is unable to improve the problems that the shaft-rod joining member is pressingly broken due to thermal expansion of the metal shaft rod joined thereto, and loosening between the shaft rod and the refractory stopper occurs due to elongation of a vertical length of the shaft rod, to cause instability in fixed (fastened) state between the shaft rod and the refractory stopper, and difficulty in ensuring gas-tightness therebetween, which leads to gas leakage.

When loosening between the shaft rod and the refractory stopper occurs due to elongation of a vertical length of the shaft rod, it is necessary to manually perform an operation of screwing the shaft rod to eliminate the loosening, so-called “retorquing operation”, during casting operation, on a constant basis. Nevertheless, it is difficult to completely eliminate the gap or loosening, because of the manual and intermittent operation. This is one of the problems in casting operation.

As mentioned above, there has not yet been provided any stopper structure designed to prevent occurrence of the loosening and gas leakage during use, while eliminating the need for a retorquing operation.
[Patent Document 1] JP 2-182357A

### DISCLOSURE OF THE INVENTION

### Problem to be Solved by the Invention

In a stopper structure comprising a refractory stopper for use in a discharge control of molten metal, and a shaft rod mounted to the refractory stopper, it is an object of the present invention to provide a technique of preventing loosening of the shaft rod during use, and gas leakage which is likely to occur when the stopper structure is designed to allow gas to pass therethrough, and a technique of allowing the stopper structure to be attached and detached relative to a driving unit by a simple operation.

### Means for Solving the Problem

The present invention provides a stopper structure comprising a refractory stopper, and a shaft rod for connecting the refractory stopper to a drive unit, wherein the shaft rod has a distal end mounted in a mounting hole of the refractory stopper. In the stopper structure, the distal end of the shaft rod has an outer peripheral surface including a first tapered sub-surface which increases in diameter toward an axially lower edge of the shaft rod, and the mounting hole of the refractory stopper has an inner surface including a second tapered sub-surface adapted to come into surface contact with the first tapered sub-surface. Further, the shaft rod is adapted to be movably fastened to the refractory stopper so as to allow the first tapered sub-surface to be brought into close surface contact with the second tapered sub-surface. The shaft rod is designed to satisfy the following formula (1): tan 0≦D/2A - - - (1), wherein: A is a length of the shaft rod between a position of the shaft rod corresponding to an upper edge surface of the refractory stopper, and a start position of the first tapered sub-surface; D is an outer diameter of the first tapered sub-surface at the start position; and θ is a taper angle of the first tapered sub-surface.

In the stopper structure of the present invention, the distal end of the shaft rod adapted to be mounted in the mounting hole of the refractory stopper is formed in a configuration satisfying the formula (1). This makes it possible to prevent loosening of the shaft rod during use, and gas leakage which is likely to occur when the stopper structure is designed to allow gas to pass therethrough.

The reason is described with reference to FIG. 1. A shaft rod 1 made of a metal has a thermal expansion coefficient fairly greater than that of a refractory stopper 2. Thus, when an outer peripheral surface of the shaft rod 1 expands in a radial direction of the shaft rod 1, the shaft rod 1 is applied with a force which causes a displacement of the shaft rod 1 in a downward direction (direction toward the distal edge of the shaft rod 1) relative to the refractory stopper 2 by a distance equal to a radial elongation value of the shaft rod×(1/tan θ), i.e., a distance equal to a radial elongation value of the shaft rod×(D/(2×tan θ)), depending on a taper angle θ of a tapered sub-surface 4a of the shaft rod 1. However, the shaft rod 1 also expands in a vertical (axial) direction. Thus, an elongation value in a length A of the shaft rod 1 between a position of the shaft rod 1 corresponding to an upper edge surface 2S of the refractory stopper, and a start position of the tapered sub-surface 4a cancels the distance equal to the radial elongation value of the shaft rod×(D/(2×tan θ)). Therefore, the taper angle θ of a tapered sub-surface 4a and the configuration of the shaft rod 1 are set to allow the distance equal to the radial elongation value of the shaft rod×(D/(2×tan θ)) to become greater than the elongation value in the length A. Specifically, when the inequality is satisfied in the formula (1) (i.e., the right-hand side is greater the left-hand side), the shaft rod 1 is constantly applied with a force which causes a displacement of the shaft rod 1 in the downward direction relative to the refractory stopper 2, during use. In response to this force, a seat plate 3 fixing (fastening) the shaft rod 1 to the refractory stopper 2 is applied with a force causing a stronger fastening action, so that the shaft rod 1 can be maintained in a firmly fixed (fastened) state without loosening. In addition, the refractory stopper 2 can be further strongly fastened between the tapered sub-surface 4a and the upper edge surface 2S of the refractory stopper. This makes it possible to desirably correct accuracy of jointing between respective members of the stopper structure. Furthermore, when a sealing material or a cushioning material is provided between the seat plate 3 and the upper edge surface 2S of the refractory stopper, loosening due to compressability of the sealing material or the cushioning material can be desirably prevented.

When the equality is satisfied in the formula (1) (i.e., the right-hand side is equal to the left-hand side), an axial elongation value in the length A of the shaft rod 1 becomes equal to an axial elongation value in the tapered sub-surface 4a of the shaft rod 1. This makes it possible to prevent loosening of the shaft rod 1 due to thermal expansion during use, because a force causing such loosing is never applied to the shaft rod 1.

As above, the stopper structure of the present invention can eliminate a problem about breakage and defective movement of the refractory stopper due to loosening between the shaft rod and the refractory stopper, to contribute to enhanced stability during use.

The stopper structure of the present invention is supplied as a product prepared in such a manner that the distal end of the shaft rod is mounted in the mounting hole of the refractory stopper. This makes it possible to reduce differences in final accuracy, which can be a factor causing instability in use of the stopper structure, such as obliquity of the stopper structure and loosening of the shaft rod, due to variation in a complicated and laborious operation, for example, an operation of embedding the distal end of the shaft rod in the refractory stopper while applying a bonding material, in a casting workplace using the stopper structure.

As a first specific mechanism for fixedly (fastenedly) mounting the shaft rod in the mounting hole of the refractory stopper, the shaft rod can have a threaded portion in an outer peripheral surface thereof at a position above the upper edge surface of the refractory stopper, and the stopper structure can further comprise a seat plate adapted to be threadingly engaged with the threaded portion of the shaft rod, and screwed toward the upper edge surface of the refractory stopper so as to allow the shaft rod to be fastened to the refractory stopper.

As a second specific mechanism, the shaft rod can include a first shaft rod segment having the distal end adapted to be mounted in the mounting hole of the refractory stopper, and a second shaft rod segment threadingly engageable with a threaded portion formed in an outer peripheral surface of the first shaft rod segment at a position above the upper edge surface of the refractory stopper, wherein the second shaft rod segment is adapted, in a state after being threadingly engaged with the threaded portion of the first shaft rod segment, to be screwed toward the upper edge surface of the refractory stopper so as to allow the first shaft rod segment to be fastened to the refractory stopper.

As a third specific mechanism, the shaft rod can include a first shaft rod segment having the distal end adapted to be mounted in the mounting hole of the refractory stopper, and a second shaft rod segment adapted to be fitted onto the first shaft rod segment and attached to the first shaft rod segment by means of a fingertip connector mechanism, wherein the second shaft rod segment is adapted, when it is attached to the first shaft rod segment by means of the fingertip connector mechanism, to be fixedly pressed against the upper edge surface of the refractory stopper so as to allow the first shaft rod segment to be fastened to the refractory stopper.

In the stopper structure of the present invention, the shaft rod can be a solid shaft rod, and the shaft rod and the refractory stopper can be simply connected to each other. Alternatively, the shaft rod can have an internal space (gas passage) for supplying gas into the mounting hole of the refractory stopper, and the refractory stopper can have an internal space (gas passage) formed in a vicinity of the mounting hole or formed to penetratingly extend from the mounting hole to a distal end of the refractory stopper, wherein gas is circulated through the space (gas passage) of at least the shaft rod to air-cool the shaft rod, or gas is injected from the distal end of the refractory stopper into molten metal. In this case, it is particularly important to prevent gas leakage between the shaft rod and the refractory stopper. For this purpose, a sealing material is preferably provided between a lower surface of the seat plate and the upper edge surface of the refractory stopper, or between a lower edge surface of the second shaft rod segment and the upper edge surface of the refractory stopper, to enhance gas-tightness.

As a material of the refractory stopper in the present invention, a refractory material commonly used for a stopper adapted to be immersed in molten metal to perform a discharge control, for example, a refractory material comprising a primary component consisting of one or a mixture of two or more of an oxide, such as alumina, silica, spinel or zirconia, and carbon or carbon compound, can be used. Further, in view of improvement in oxidation resistance and/or strength, the above refractory material can contain one or more of various carbides, various nitrides, boride and metal.

As a material of the shaft rod and the seat plate in the present invention, a metal commonly used for a shaft rod and a seat plate, such as carbon steel, chromium-molybdenum steel or stainless steel, can be used. A ceramic material is highly likely to be broken during use, and therefore it is desirable to limitedly use the ceramic material in a part of a member, such as the first shaft rod having the distal edge to be mounted in the refractory stopper, or the seat plate, which is less likely to receive a large moment in a concentrated manner.

The above stopper structure of the present invention can be produced by charging a kneaded mixture (ingredients) as a refractory material of a refractory stopper, into a flexible mold, such as a rubber mold, together with a binder, and forming the mixture through an isostatic pressing process, in the same manner as that for a conventional long refractory stopper. Specifically, in advance of charging the refractory material into the mold, the distal end of the shaft rod is set in the mold. Then, the refractory material is charged around the distal end of the shaft rod, and formed to obtain a molded product in which the shaft rod is mounted to the refractory material of a refractory stopper. Subsequently, the molded product is subjected to drying, as needed, and subjected to burning in a non-oxidation atmosphere at a temperature of about 800 to 1200° C., to obtain a stopper structure comprising a refractory stopper and the shaft rod mounted in the refractory stopper.

It is necessary to pre-define a space around the remaining outer peripheral surface (1a and 1b in FIG. 1) other than the first tapered sub-surface (4a in FIG. 1) of the shaft rod in a state after being mounted in the refractory stopper, in order to absorb thermal expansion of the shaft rod along with an increase in temperature. This space can be obtained by pre-forming, on the outer peripheral surface of the shaft rod, an organic film which is vanished at about 800° C. at a maximum, such as paraffin, and subjecting the film to forming, (drying, as needed) and burning together with the refractory material.

In the present invention, the stopper structure having the refractory stopper combined with the shaft rod can be obtained by preparing a refractory stopper having a through-hole extending generally along an axis of the refractory stopper, and a shaft rod having a portion adapted to be mounted inside an upper end region of the refractory stopper, separately, and inserting the shaft rod into the through-hole of the refractory stopper from the side of a lower (distal) end of the refractory stopper. However, in the present invention, it is not particularly necessary to perform an operation of joining the refractory stopper and the shaft rod together using a bonding material under adjustment at a high degree of accuracy. Thus, as mentioned above, it is preferable to employ the following combined scheme of production method comprising the steps of:

(1) setting the distal end of the shaft rod at a given position in a mold for forming the refractory stopper,

(2) charging a refractory mixture (ingredients) around the distal end of the shaft rod in the mold,

(3) applying pressure on the refractory mixture (ingredients) in the mold to form the refractory stopper in a manner combined with the distal end of the shaft rod, and

(4) subjecting the obtained molded product to burning.

Finally, in a production plant before shipment or in a casting workplace, other optional components, such as the sealing material and the seat plate, are mounted to the burned product to form a single unit. In this manner, the stopper structure of the present invention is completed.

As above, the shaft rod and the refractory stopper are produced in a combined manner. This makes it possible to eliminate the need for a complicated/laborious and unstable operation, such as an operation of applying mortar, in a casting workplace, and obtain a high-strength stopper structure having only a contact region between the refractory stopper and the shaft rod without any joint or seam therebetween causing breakage of the refractory stopper and gas leakage.

The present invention has the following advantageous effects:
1. Loosening of the joining between the refractory stopper and the shaft rod during use can be prevented to reduce a risk of breakage of the stopper structure due to a moment, such as bending moment, applied to a part of the stopper member in a concentrated manner;
2. The joining between the refractory stopper and the shaft rod is not loosened during use. This makes it possible to prevent gas leakage which is likely to occur when the stopper structure is designed to allow gas to pass therethrough;
3. An operation which is complicated/laborious, and unstable in accuracy of joining between the refractory stopper and the shaft rod, for example, an operation of installing a member, such as a joining member between the refractory stopper and the shaft rod, onto the refractory stopper using mortar, can be omitted to improve operating efficiency and enhance the accuracy of joining between the refractory stopper and the shaft rod;
4. A retorquing operation which has to otherwise be highly frequently performed for a fixing (fastening) portion between the refractory stopper and the shaft rod can be eliminated to contribute to laborsaving;
5. In a conventional stopper structure, joining between a refractory stopper and a shaft rod is loosened during use, and thereby only a fixing (fastening) mechanism capable of coping with a retorquing operation, such as thread-based joining, can be employed. In the present invention, the joining between the refractory stopper and the shaft rod is not loosened during use. This allows a fixing (fastening) mechanism using a fingertip connector mechanism to be employed. Thus, the shaft rod can be fixed (fastened) to the refractory stopper in conjunction with an operation of connecting two shaft rod segments together in a simple manner. This makes it possible to improve laborsaving and operating efficiency, as compared with a conventional technique requiring a plurality of operations, while reducing differences among individuals in the fixing (fastening) operation and the retorquing operation, to allow a casting operation to be stably performed using the stopper structure; and
6. The refractory stopper and the shaft rod can be produced in a simple manner by the combined scheme of production method. This makes it possible to facilitate streamlining, such as simplification in production process, reduction in process time, and laborsaving.

### BRIEF DESCRIPTION OF DRAWINGS

FIG. 1 is a sectional view showing a stopper structure according to one embodiment of the present invention.

FIG. 2 is a sectional view showing a stopper structure according to another embodiment of the present invention.

FIG. 3 is a sectional view showing a stopper structure according to yet another embodiment of the present invention.

FIG. 4 is a sectional view showing a stopper structure according to still another embodiment of the present invention.

FIG. 5 is a sectional view showing a stopper structure of the present invention, during use.

FIG. 6 is a sectional view showing a conventional stopper structure.

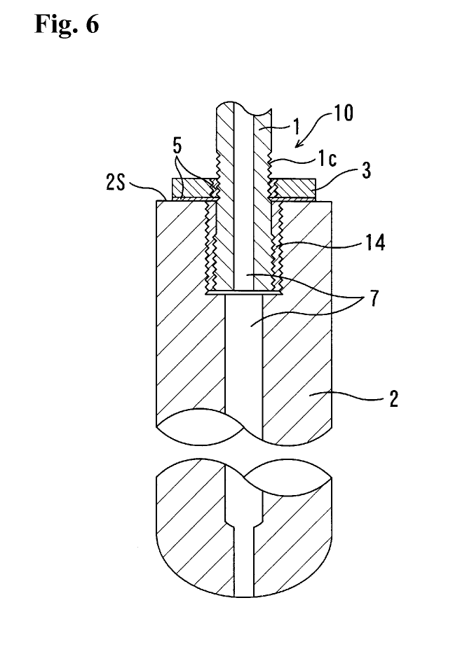

### EXPLANATION OF CODES

1: shaft rod
1a: small-diameter portion
1b: large-diameter portion
1c: threaded portion
1-1: first shaft rod segment
1-1a: threaded portion
1-2: second shaft rod segment
2: refractory stopper
2a: mounting hole
2S: upper edge surface of refractory stopper
3: seat plate
4a: first tapered sub-surface
4b: second tapered sub-surface
5: sealing material
6: space
7: gas passage
8: drive unit
9: molten-metal discharge nozzle
10: stopper structure
11: molten metal
12: molten metal vessel
13: refractory material
14: shaft-rod joining member
15: cam lock mechanism
15a: cam lock body
15b: engagement portion
16: O-ring

### BEST MODE FOR CARRYING OUT THE INVENTION

The present invention is described based on a preferred embodiment thereof

### First Embodiment

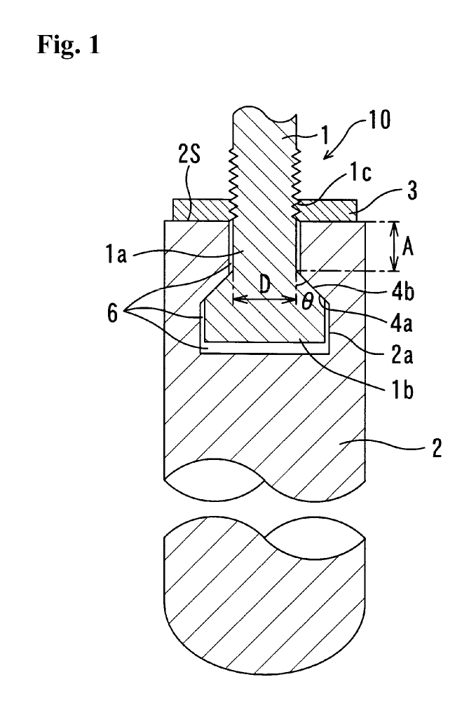

FIG. 1 is a sectional view showing a stopper structure according to a first embodiment of the present invention.

A stopper structure 10 illustrated in FIG. 1 comprises a refractory stopper 2, and a metal shaft rod 1 which has a distal end mounted in a mounting hole 2a of the refractory stopper 2 through a space 6 serving as a means for absorbing a thermal expansion of the distal end of the shaft rod 1.

The distal end of the shaft rod 1 is formed in a stepped configuration which comprises a small-diameter portion 1a formed on the side of a base edge of the shaft rod 1, and a large-diameter portion 1b formed on the side of a distal edge of the shaft rod 1 to have a diameter greater than that of the small-diameter portion 1a. The distal end of the shaft rod 1 has an outer peripheral surface including a first tapered sub-surface 4a between the small-diameter portion 1a and large-diameter portion 1b. The mounting hole 2a of the refractory stopper 2 is formed in a configuration similar to that of the distal end of the shaft rod 1. The mounting hole 2a of the refractory stopper 2 has an inner surface including a second tapered sub-surface 4b adapted to come into surface contact with the first tapered sub-surface 4a.

The shaft rod 1 has a threaded portion 1c in the outer peripheral surface thereof at a position above an upper edge surface 2S of the refractory stopper. A seat plate 3 is threadingly engaged with the threaded portion 1c of the shaft rod 1, and screwed toward the upper edge surface 2S of the refractory stopper, so that the first tapered sub-surface 4a is brought into close surface contact with the second tapered sub-surface 4b, and the shaft rod 1 and the refractory stopper 2 are fixedly fastened together. Specifically, along with screwing (i.e., tightening) of the seat plate 3, the shaft rod 1 is moved upwardly, and fixed in such a manner as to clampingly fasten the refractory stopper 2 between the seat plate 3 and the first tapered sub-surface 4b as a contact surface with the refractory stopper 2.

The refractory stopper 2 in the first embodiment has an integral structure without any joint and seam in radial, circumferential and axial directions thereof, at least in a region thereof for mounting thereon the distal end of the shaft rod 1. The remaining region other than the shaft rod mounting region of the refractory stopper 2 can have an integral structure or can have a divided structure.

In the above stopper structure, given that: a length of the shaft rod 1 between a position of the shaft rod 1 corresponding to the upper edge surface 2S of the refractory stopper, and a start position of the first tapered sub-surface 4a, is A; an outer diameter of the first tapered sub-surface 4a at the start position is D; and a taper angle of the first tapered sub-surface 4a is θ, the distal end of the shaft rod 1 is formed in a configuration satisfying the aforementioned formula (1). This configuration makes it possible to prevent lowing of a fastening force between the first tapered sub-surface 4a and the seat plate 3 even if the shaft rod 1 expands during use, as mentioned above.

With a view to avoiding local stress concentration at a certain point in a contact region between the seat plate 3 and the upper edge surface 2S of the refractory stopper, or increasing a contact surface area therebetween, or distributing an external force applied to the contact region to avoid point contact, a cushioning material, such as a sheet made of ceramic fibers and formed to have a thickness of about several mm or less, can be provided between the seat plate 3 and the upper edge surface 2S of the refractory stopper.

### Second Embodiment

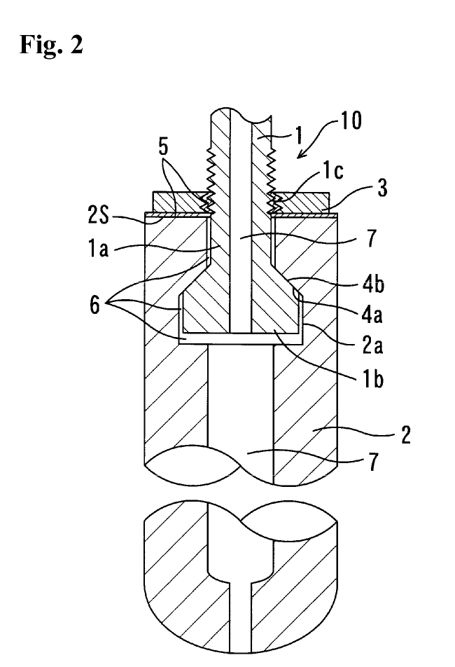

FIG. 2 is a sectional view showing a stopper structure according to a second embodiment of the present invention. A stopper structure 10 according to the second embodiment is internally provided with a gas passage 7. A contact/joining mechanism between a shaft rod 1 and a refractory stopper 2 in the second embodiment is the same as that in the first embodiment.

In the second embodiment, the shaft rod 1 is internally provided with a gas passage 7 for supplying gas into a mounting hole 2a of the refractory stopper 2, and the refractory stopper 2 is internally provided with a gas passage 7 penetratingly extending from the mounting hole 2a to a distal end thereof, so as to inject gas from the distal end of the refractory stopper into molten metal, or gas is supplied to the gas passage 7 of the shaft rod 1 to air-cool the shaft rod 1.

Considering that each of the shaft rod 1 and the refractory stopper 2 is internally provided with the gas passage 7 in the above manner, in the second embodiment, a sealing material 5 is provided in each of two contact regions between a lower surface of a seat plate 3 and an upper edge surface 2S of the refractory stopper, and between an inner surface of the seat plate 5 and an outer peripheral surface of the shaft rod 1, to enhance gas-tightness.

As the sealing material 5, a material pre-formed in a sheet shape, or an unshaped material, such as mortar or adhesive, can be used. Preferably, as the sealing material 5 to be provided between the lower surface of the seat plate 3 and the upper edge surface 2S of the refractory stopper, a sheet-shaped sealing material having a certain level of shape retainability is used to fully fill a gap therebetween even after being clamped therebetween. In this case, in order to reliably seal the entire contact region, the sheet-shaped sealing material is preferably formed in a configuration in a pre-clamped state, which has an inner diameter approximately equal to an outer diameter of the shaft rod 1, an outer diameter equal to or greater than at least an outer diameter of the seat plate 3, and a thickness of about 2 to 10 mm, preferably about 3 to 5 mm, i.e., a configuration capable of, in a state after the seat plate 3 is tightened to fix the shaft rod 1 to the refractory stopper 2, allowing the sealing material 5 to be in close contact with each of the lower surface of the seat plate 3 and the upper edge surface 2S of the refractory stopper, while preventing occurrence of breakage, such as crack, of the sealing material 5.

Preferably, as the sealing material 5 to be provided between the inner surface of the seat plate 3 and the outer peripheral surface of the shaft rod 1, a mortar-like unshaped bonding material is used to maintain gas-tightness even after the screwing operation.

In terms of composition, the sealing material 5 can be a carbon sheet commonly used for providing enhanced contact to prevent gas leakage, a sheet made of a refractory material containing: a component commonly used as a refractory raw material, such as, alumina, silica, zirconia, other oxide, nitride or carbide, by itself or in the form of a compound or mixture thereof; and optionally a glass component and/or metal, or an unshaped refractory material containing the same component as that of each of the above sheets, irrespective of the name used. In the sheet-shaped sealing material, it is preferable, but not limited to, to have plasticity at a level allowing the sealing material to come into close contact with each of the lower surface of the seat plate 3 and the upper edge surface 2S of the refractory stopper, without any gap, when the seat plate is tightened by a torque of about 100 N·m. In the sealing material including the unshaped sealing material, having higher plasticity than the above level, the plasticity is preferably limited to a level capable of keeping the sealing material from further deforming beyond a close contact state to form a gap. Specifically, it is preferable to use a thin film-shaped sealing material, or apply a paint-like liquid sealing material.

In the stopper structure of the present invention, the close surface contact between the first tapered sub-surface 4a and the second tapered sub-surface 4b, as described in connection with the first embodiment, can prevent gas leakage from between the shaft rod 1 and the refractory stopper 2 to some extent. Particularly, a mutual surface accuracy between the first tapered sub-surface 4a and the second tapered sub-surface 4b can be enhanced by forming a member to have surface accuracy at a level equal to or higher than the fine finishing (represented by three inversed triangles according finishing symbol of JIS), and embedding the member in the refractory stopper 2 to define the first tapered sub-surface 4a. Further, a gap therebetween causing gas leakage can be prevented by tightening the first tapered sub-surface 4a having high surface accuracy against the second tapered sub-surface 4b to firmly fix them together. Nevertheless, in view of more reliably preventing gas leakage between the shaft rod 1 and the refractory stopper 2, it is preferable to provide the sealing material 5 as in the second embodiment illustrated in FIG. 2. An additional sealing material, such as a carbon sheet, can be provided between the first tapered sub-surface 4a and the second tapered sub-surface 4b. However, gas-tightness between the first tapered sub-surface 4a and the second tapered sub-surface 4b can be ensured by forming the first tapered sub-surface 4a to have surface accuracy at a level equal to or higher than the fine finishing (represented by three inversed triangles according finishing symbol of JIS), as described above. In this case, the additional sealing material can be omitted.

### Third Embodiment

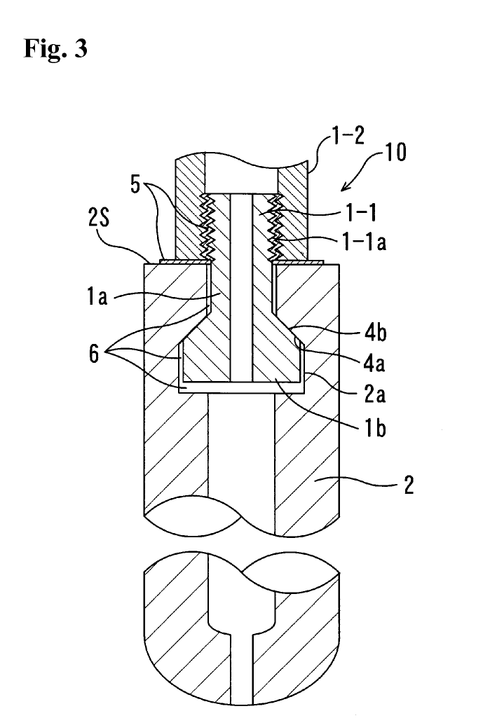

FIG. 3 is a sectional view showing a stopper structure according to a third embodiment of the present invention. The stopper structure according to the third embodiment is designed to divide a shaft rod 1 into a first shaft rod segment 1-1 and a second shaft rod segment 1-2.

The first shaft rod segment 1-1 has a distal end mounted in a mounting hole 2a of a refractory stopper 2, and a threaded portion 1-1a formed in an outer peripheral surface thereof at a position above an upper edge surface 2S of the refractory stopper 2. The second shaft rod segment 1-2 is threadingly engaged with the threaded portion 1-1a of the first shaft rod segment 1-1, and screwed toward the upper edge surface 2S of the refractory stopper. Thus, a lower edge surface of the second shaft rod segment 1-2 is brought into contact with the upper edge surface 2S of the refractory stopper first shaft rod segment, and the first shaft rod segment 1-1 is moved upwardly, so that a first tapered sub-surface 4a is brought into close surface contact with a second tapered sub-surface 4b to allow be the second shaft rod segment 1-2 to be fixedly fastened to the refractory stopper 2.

In the third embodiment, the stopper structure 10 internally has a gas passage 7, and a sealing material 5 is provided in each of two contact region between a lower edge surface of the second shaft rod segment 1-2 and an upper edge surface 2S of the refractory stopper, and around the threaded portion 1-1a, to enhance gas-tightness, in the same manner as that in the second embodiment. In cases where the gas passage 7 is not provided, it is not necessary to provide these sealing materials 5. However, with a view to avoiding local stress concentration in the contact region between the lower edge surface of the second shaft rod segment 1-2 and the upper edge surface 2S of the refractory stopper, or increasing a contact surface area therebetween, or distributing an external force applied to the contact region to avoid point contact, the seat plate 3 and the cushioning material, such as a sheet made of ceramic fibers and formed to have a thickness of about several mm or less, as described in connection with the first embodiment, can be secondarily provided

### Fourth Embodiment

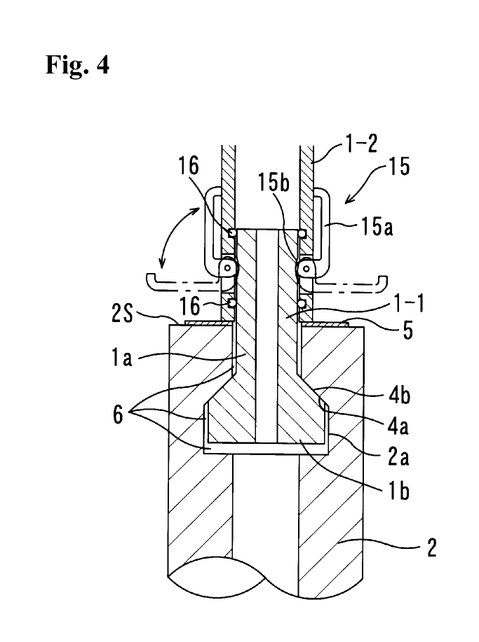

FIG. 4 is a sectional view showing a stopper structure according to a fourth embodiment of the present invention. The stopper structure according to the fourth embodiment is designed to divide a shaft rod 1 into a first shaft rod segment 1-1 and a second shaft rod segment 1-2, and fixedly connect them together by means of a fingertip connector mechanism.

The first shaft rod segment 1-1 has a distal end mounted in a mounting hole 2a of a refractory stopper 2, and the second shaft rod segment 1-2 is fitted onto the first shaft rod segment 1-1. As the fingertip connector mechanism for fixedly fastening the first shaft rod segment 1-1 and the second shaft rod segment 1-2 together, a cam lock mechanism 15 is provided.

The cam lock mechanism 15 comprises a cam lock body 15a swingably attached to the second shaft rod segment 1-2, and an engagement portion 15b formed in an outer peripheral surface of the first shaft rod segment 1-1 and adapted to be engaged with the cam lock body 15a. When the cam lock body 15a is swingingly moved to a lock position (indicated by the solid line in FIG. 4), a distal end of the cam lock body 15a is brought into engagement with the engagement portion 15b to allow the first shaft rod segment 1-1 and the second shaft rod segment 1-2 to be fixedly connected together. A vertical position of the engagement portion 15b or a thickness of a cushioning material or a seat plate provided between a lower edge surface of the second shaft rod segment 1-2 and an upper edge surface 2S of the refractory stopper 2, can be adjusted in such a manner that, when the first shaft rod segment 1-1 and the second shaft rod segment 1-2 are fixedly connected together by the cam lock mechanism 15, the second shaft rod segment 1-2 is fixed while being pressed against the upper edge surface 2S of the refractory stopper 2, and the first shaft rod segment 1-1 is fastened to the refractory stopper 2. Thus, a first tapered sub-surface 4a is brought into close surface contact with a second tapered sub-surface 4b, in the same manner as that in the first to third embodiments. When the cam lock body 15a is swingingly moved to a lock release position (indicated by the broken line in FIG. 4), the engagement between the cam lock body 15a and the engagement portion 15a is released to allow the second shaft rod segment 1-2 to be detached.

In the fourth embodiment, the stopper structure 10 internally has a gas passage 7, and a sealing material 5 is provided in a contact region between the lower edge surface of the second shaft rod segment 1-2 and the upper edge surface 2S of the refractory stopper, in the same manner as that in the second embodiment. Further, an O-ring 16 is provided in a contact region between the first shaft rod segment 1-1 and the second shaft rod segment 1-2. In cases where the gas passage 7 is not provided, it is not necessary to provide the sealing material 5 and the O-ring 16. However, with a view to avoiding local stress concentration in the contact region between the lower edge surface of the second shaft rod segment 1-2 and the upper edge surface 2S of the refractory stopper, or increasing a contact surface area therebetween, or distributing an external force applied to the contact region to avoid point contact, the seat plate 3 and the cushioning material, such as a sheet made of ceramic fibers and formed to have a thickness of about several mm or less, as described in connection with the first embodiment, can be secondarily provided.

### Fifth Embodiment

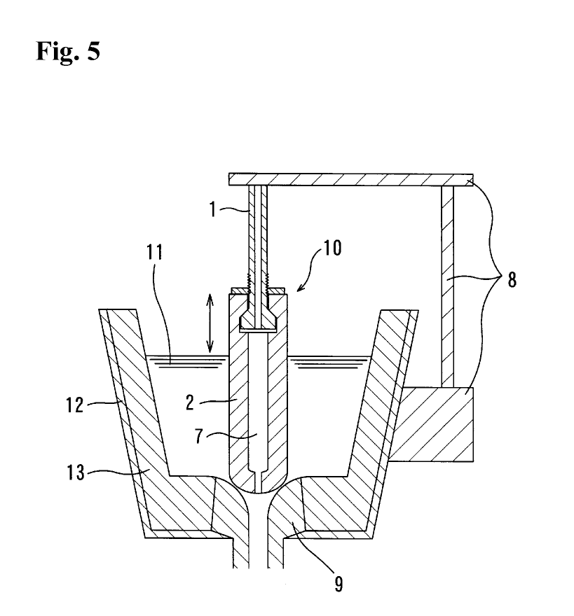

FIG. 5 is a sectional view showing a stopper structure of the present invention, during use. The stopper structure 10 illustrated in FIG. 5 is the same as that illustrated in FIG. 2.

The shaft rod 1 of the stopper structure 10 has a base end connected to a drive unit 8 to allow the stopper structure 10 to be moved vertically, and the stopper structure 10 is disposed at a position directly above a molten-metal discharge nozzle 9 provided in a bottom wall of a molten metal vessel 12 lined with a refractory material 13. The refractory stopper 2 of the stopper structure 10 is partly immersed in molten metal 11. The stopper structure 10 is vertically moved by the drive unit 8 to selectively open and close an interspace defined between a fitting portion thereof and an upper end of the molten-metal discharge nozzle 9, or adjust an opening degree of the interspace, so as to perform a discharge control of the molten metal.

Further, according to need, inert gas is introduced from the base end of the shaft rod 1 into the gas passage 7, and injected from the distal end of the refractory stopper into the molten metal 11.

1. A stopper structure comprising a refractory stopper, and a shaft rod for connecting said refractory stopper to a drive unit, said shaft rod having a distal end mounted in a mounting hole of said refractory stopper, wherein:
said distal end of said shaft rod has an outer peripheral surface including a first tapered sub-surface which increases in diameter toward an axially lower edge of said shaft rod;
said mounting hole of said refractory stopper has an inner surface including a second tapered sub-surface adapted to come into surface contact with said first tapered sub-surface; and
said shaft rod is adapted to be movably fastened to said refractory stopper so as to allow said first tapered sub-surface to be brought into close surface contact with said second tapered sub-surface, said shaft rod being designed to satisfy the following formula (1):
tan θ≦D/2A (1)
, wherein: A is a length of said shaft rod between a position of said shaft rod corresponding to an upper edge surface of said refractory stopper, and a start position of said first tapered sub-surface; D is an outer diameter of said first tapered sub-surface at said start position; and θ is a taper angle of said first tapered sub-surface.

2. The stopper structure as defined in claim 1, wherein said shaft rod has a threaded portion in an outer peripheral surface thereof at a position above said upper edge surface of said refractory stopper, and wherein said stopper structure further comprises a seat plate adapted to be threadingly engaged with said threaded portion of said shaft rod, and screwed toward said upper edge surface of said refractory stopper so as to allow said shaft rod to be fixedly fastened to said refractory stopper.

3. The stopper structure as defined in claim 1, wherein said shaft rod has a threaded portion in an outer peripheral surface thereof at a position above said upper edge surface of said refractory stopper, and wherein said stopper structure further comprises: a seat plate adapted to be threadingly engaged with said threaded portion of said shaft rod, and screwed toward said upper edge surface of said refractory stopper so as to allow said shaft rod to be fixedly fastened to said refractory stopper; and a sealing material provided between a lower surface of said seat plate and said upper edge surface of said refractory stopper.

4. The stopper structure as defined in claim 1, wherein said shaft rod includes a first shaft rod segment having said distal end adapted to be mounted in said mounting hole of said refractory stopper, and a second shaft rod segment threadingly engageable with a threaded portion formed in an outer peripheral surface of said first shaft rod segment at a position above said upper edge surface of said refractory stopper, said second shaft rod segment being adapted, in a state after being threadingly engaged with said threaded portion of said first shaft rod segment, to be screwed toward said upper edge surface of said refractory stopper so as to allow said first shaft rod segment to be fixedly fastened to said refractory stopper.

5. The stopper structure as defined in claim 1, wherein said shaft rod includes a first shaft rod segment having said distal end adapted to be mounted in said mounting hole of said refractory stopper, and a second shaft rod segment threadingly engageable with a threaded portion formed in an outer peripheral surface of said first shaft rod segment at a position above said upper edge surface of said refractory stopper, said second shaft rod segment being adapted, in a state after being threadingly engaged with said threaded portion of said first shaft rod segment, to be screwed toward said upper edge surface of said refractory stopper so as to allow said first shaft rod segment to be fixedly fastened to said refractory stopper, and wherein said stopper structure further comprised a sealing material provided between a lower edge surface of said second shaft rod segment and said upper edge surface of said refractory stopper.

6. The stopper structure as defined in claim 1, wherein said shaft rod includes a first shaft rod segment having said distal end adapted to be mounted in said mounting hole of said refractory stopper, and a second shaft rod segment adapted to be fitted onto said first shaft rod segment and attached to said first shaft rod segment by means of a fingertip connector mechanism, said second shaft rod segment being adapted, when it is attached to said first shaft rod segment by means of said fingertip connector mechanism, to be fixedly pressed against said upper edge surface of said refractory stopper so as to allow said first shaft rod segment to be fixedly fastened to said refractory stopper.

7. The stopper structure as defined in claim 1, wherein said shaft rod includes a first shaft rod segment having said distal end adapted to be mounted in said mounting hole of said refractory stopper, and a second shaft rod segment adapted to be fitted onto said first shaft rod segment and attached to said first shaft rod segment by means of a fingertip connector mechanism, said second shaft rod segment being adapted, when it is attached to said first shaft rod segment by means of said fingertip connector mechanism, to be fixedly pressed against said upper edge surface of said refractory stopper so as to allow said first shaft rod segment to be fixedly fastened to said refractory stopper, and wherein said stopper structure further comprised a sealing material provided between a lower edge surface of said second shaft rod segment and said upper edge surface of said refractory stopper.

8. The stopper structure as defined in claim 1, wherein said shaft rod has an internal space adapted to allow gas to pass therethrough, and communicated with said mounting hole of said refractory stopper or a hole of said refractory stopper penetratingly extending to a distal end thereof

9. A method of producing the stopper structure as defined in claim 1, comprising the steps of:
setting said distal end of said shaft rod at a given position in a mold for forming said refractory stopper;
charging a refractory mixture (ingredients) around said distal end of said shaft rod in said mold;
applying pressure on said refractory mixture (ingredients) in said mold to form said refractory stopper in a manner combined with said distal end of said shaft rod; and
subjecting said obtained molded product to burning.

10. The stopper structure as defined in claim 2, wherein said shaft rod has an internal space adapted to allow gas to pass therethrough, and communicated with said mounting hole of said refractory stopper or a hole of said refractory stopper penetratingly extending to a distal end thereof

11. The stopper structure as defined in claim 3, wherein said shaft rod has an internal space adapted to allow gas to pass therethrough, and communicated with said mounting hole of said refractory stopper or a hole of said refractory stopper penetratingly extending to a distal end thereof

12. The stopper structure as defined in claim 4, wherein said shaft rod has an internal space adapted to allow gas to pass therethrough, and communicated with said mounting hole of said refractory stopper or a hole of said refractory stopper penetratingly extending to a distal end thereof

13. The stopper structure as defined in claim 5, wherein said shaft rod has an internal space adapted to allow gas to pass therethrough, and communicated with said mounting hole of said refractory stopper or a hole of said refractory stopper penetratingly extending to a distal end thereof

14. The stopper structure as defined in claim 6, wherein said shaft rod has an internal space adapted to allow gas to pass therethrough, and communicated with said mounting hole of said refractory stopper or a hole of said refractory stopper penetratingly extending to a distal end thereof.

15. The stopper structure as defined in claim 7, wherein said shaft rod has an internal space adapted to allow gas to pass therethrough, and communicated with said mounting hole of said refractory stopper or a hole of said refractory stopper penetratingly extending to a distal end thereof.
